(19) United States
(12) Patent Application Publication
(10) Pub. No.: US 2024/0318284 A1
(43) Pub. Date: Sep. 26, 2024

(54) ALUMINUM ALLOY MELT

(71) Applicant: Industrial Technology Research Institute, Hsinchu (TW)

(72) Inventors: Yu-Hsien Chou, Tainan City (TW); Chi-San Chen, Kaohsiung City (TW); Heng-Yi Tsai, Changhua County (TW); Chang-Ching Chen, Tainan City (TW)

(73) Assignee: Industrial Technology Research Institute, Hsinchu (TW)

(21) Appl. No.: 18/731,371

(22) Filed: Jun. 3, 2024

Related U.S. Application Data
(62) Division of application No. 17/549,895, filed on Dec. 14, 2021.

(30) Foreign Application Priority Data
Nov. 16, 2021 (TW) 110142497

(51) Int. Cl. C22C 21/02; B22F 1/052; B22F 1/065; B22F 1/142

(52) U.S. Cl. CPC C22C 21/02; B22F 1/052; B22F 1/065; B22F 1/142; B22F 2202/11; B22F 2301/052; B22F 2304/10

(57) ABSTRACT

An aluminum alloy melt is manufactured by adopting an aluminum alloy powder through laser laminated manufacturing. The aluminum alloy powder includes Si: 2.0-4.5 wt %; Mg: 0.1-1.3 wt %; Fe: 0.07-0.65 wt %; Cu: 0.35 wt % or less; Cr: 0.02-0.32 wt %; Zn: 0.23 wt % or less; Ti: 0.23 wt % or less; Mn: 0.13 wt % or less; and the rest is aluminum. The aluminum alloy powder further includes inevitable impurities.

### CROSS-REFERENCE TO RELATED APPLICATION

This application is a divisional application of and claims the priority benefit of U.S. patent application Ser. No. 17/549,895, filed on Dec. 14, 2021. The prior application Ser. No. 17/549,895 claims the priority benefit of Taiwan application serial no. 110142497, filed on Nov. 16, 2021. The entirety of each of the above-mentioned patent applications is hereby incorporated by reference herein and made a part of this specification.

### TECHNICAL FIELD

The disclosure relates to an aluminum alloy melt formed by laser laminated manufacturing.

### BACKGROUND

A manufacturing process of a semiconductor product is complex and usually requires at least hundreds of recurrent steps. Furthermore, products advance rapidly, and equipment requires high precision. There are also many types of parts. There are approximately hundreds of or thousands of different parts in one single piece of equipment. However, for replacement and repair of semiconductor equipment parts, there are common issues such as instant material supply and complex geometry processing. Furthermore, due to some factors such as poor control of purchasing lead time and a huge disparity among unit cost of different parts, part inventory management is getting more complicated.

In addition, for replacement and repair of semiconductor equipment parts, there are issues such as instant material supply and complex geometry processing. Semiconductor inventory management has become a key issue in the entire supply chain. Furthermore, although it is known that a service life of a part is limited, it is still hard to predict when a part will be damaged. Therefore, there is an increase in the cost of the inventory of spare parts, and the spare parts in the inventory may have a risk of being eliminated.

In metal laminated manufacturing, there is a favorable feature that a geometric structure of a product is not limited. A semi-finished product exhibits the features of near-net shape and advanced digital manufacturing, which not only reduces manufacturing procedures in the conventional metal industry but also has an advantage of inventory de-stocking.

However, in laminated manufacturing, there are relatively strict requirements for raw materials. To meet the applicability of laser laminated manufacturing, selected materials are required to be provided in a form of powder. After powder materials are melted rapidly, the materials are recombined. The entire process involves a change in the state of matter such as rapid melting and solidification of the materials. Therefore, an extreme high standard of properties of the applied materials is required.

Spare parts of semiconductor equipment are required to be lightweight and exhibits high intensity. Furthermore, its surface has to be processed with anodizing. Currently, AlSi₁₀Mg is mainly adopted as an aluminum alloy powder material for laminated manufacturing. However, a content of Si in AlSi₁₀Mg is high (the content of Si: 10 wt %). There is a relatively large disparity between an electric potential difference of Al and an electric potential difference of Si, so there is a difference in height in a microscopic structure after anodizing, which makes an anodic film fail to meet the requirements. The higher the content of Si is, the deeper the color of the anodic film is. In addition, with the higher content of Si in the aluminum alloy, segregation tends to occur, and the anodic film tends to deteriorate due to defects. As a result, the density reduces, and the erosion resistance is thus decreased. Therefore, AlSi₁₀Mg cannot serve as a material for a spare part of semiconductor equipment.

Currently, a 6061 aluminum alloy is still adopted as a material for a spare part. A content of Si in the 6061 aluminum alloy is low (the content of Si: 0.4 wt % to 0.8 wt %). Hence, an even light-colored or even colorless anodic film can be formed through anodizing. However, a temperature range of the solid phase and a temperature range of the liquid phase of the 6061 aluminum alloy are small, so the 6061 aluminum alloy exhibits unfavorable castability, which makes it unsuitable for laminated manufacturing.

### SUMMARY

The aluminum alloy melt of the disclosure is manufactured by adopting an aluminum alloy powder through laser laminated manufacturing. The aluminum alloy powder for laser laminated manufacturing of the disclosure includes: Si: 2.0 to 4.5 wt %; Mg: 0.1 to 1.3 wt %; Fe: 0.07 to 0.65 wt %; Cu: 0.35 wt % or less; Cr: 0.02 to 0.32 wt %; Zn: 0.23 wt % or less; Ti: 0.23 wt % or less; Mn: 0.13 wt % or less. The rest of the aluminum alloy powder is aluminum and inevitable impurities.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic diagram of an aluminum alloy melt according to an embodiment of the disclosure.

FIG. 2A is a metallographical diagram of aluminum alloy powders of Experiment Example 1.

FIG. 2B is a metallographical front-view of an aluminum alloy melt of Experiment Example 1.

FIG. 2C is a metallographical cross-sectional diagram of the aluminum alloy melt of Experiment Example 1.

FIG. 2D is a chart illustrating a stress-strain curve of the aluminum alloy melt of Experiment Example 1.

FIG. 3 is a metallographical diagram of a 6061 aluminum alloy block of Comparative Example 1.

FIG. 4A is a metallographical diagram of aluminum alloy powders of Comparative Example 2.

FIG. 4B is a metallographical front-view of an aluminum alloy melt of Comparative Example 2.

### DETAILED DESCRIPTION OF DISCLOSED EMBODIMENTS

The disclosure is directed to an aluminum alloy powder for laser laminated manufacturing exhibiting favorable castability.

The disclosure further provides an aluminum alloy melt exhibiting favorable yield strength and tensile strength.

In the aluminum alloy material of the disclosure, by adjusting compositions of trace elements Si and Mg, castability of a conventional 6061 aluminum alloy is increased and liquid metal is supplied sufficiently so that the 6061 aluminum alloy is more favorable in a laminated manufacturing molding process. In addition, a spherical powder exhibiting compositional uniformity is manufactured with the aluminum alloy after tempering through a method of gas powder injection. Inventory management of semiconductor equipment parts may be facilitated through a laser laminated technology. Furthermore, the aluminum alloy melt of laminated manufacturing exhibits favorable yield strength and tensile strength. Since a complex and intricate structure may be directly formed through laminated manufacturing, compared with multiple manufacturing processes of conventional aluminum alloy processing, a required complex part is manufactured instantly and rapidly with different equipment.

An aluminum alloy powder for laser laminated manufacturing is manufactured so that an aluminum alloy melt manufactured through laminated manufacturing exhibits favorable mechanical properties, and the aluminum alloy powder may also be favorable for further anodizing as a spare part of semiconductor equipment. Accordingly, the disclosure provides an aluminum alloy powder having the features above.

In an embodiment, an aluminum alloy powder for laser laminated manufacturing includes: Si: 2.0 to 4.5 wt %; Mg: 0.1 to 1.3 wt %; Fe: 0.07 to 0.65 wt %; Cu: 0.35 wt % or less; Cr: 0.02 to 0.32 wt %; Zn: 0.23 wt % or less; Ti: 0.23 wt % or less; Mn: 0.13 wt % or less. The rest of the aluminum alloy powder is aluminum, and inevitable impurities may be included. In the aluminum alloy powder, a content of Si is, for example, 3.0 wt % to 4.0 wt %, and a content of Mg is, for example, 0.1 wt % to 1.0 wt %, such as 0.4 wt % to 0.7 wt %. A grain size of the aluminum alloy powder is, for example, 20 μm to 65 μm.

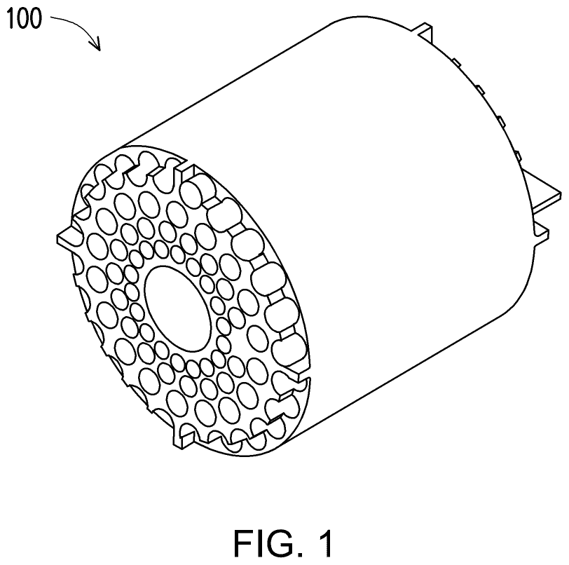

FIG. 1 is a schematic diagram of an aluminum alloy melt according to an embodiment of the disclosure. In FIG. 1, an aluminum alloy melt 100 is manufactured by adopting the aluminum alloy powder of a previous embodiment through laser laminated manufacturing. It is noted that FIG. 1 is a schematic diagram, representing that the aluminum alloy melt has a complex and intricate structure, and it is not intended to limit the scope of the disclosure. A size in FIG. 1 does not represent an actual size.

In an embodiment, yield strength of the aluminum alloy melt may be greater than 100 MPa, such as greater than 125 MPa. Tensile strength of the aluminum alloy melt may be 150 MPa to 300 MPa, such as 200 MPa to 300 MPa.

Experiments will be described in the following to verify the effects of the disclosure; however, the disclosure is not limited to the contents described in the following.

### Experimental Example 1

A conventional 6061 aluminum alloy (the composition thereof is shown in Table 1) was adopted. After the 6061 aluminum alloy was melted, Si and Mg were added. The composition ratio thereof in the entire aluminum alloy is shown as Table 2 below.

TABLE 1

| Si | Fe | Cu | Mn | Mg |
|---|---|---|---|---|
| 0.4 to 0.8 wt. % | Max. 0.7 wt. % | 0.15 to 0.4 wt. % | Max. 0.15 wt. % | 0.8 to 1.2 wt. % |

| Cr | Zn | Ti | Others |
|---|---|---|---|
| 0.04 to 0.35 wt. % | Max. 0.25 wt. % | Max. 0.15 wt. % | Max. 0.15 wt. % |

*The rest of the composition is aluminum.

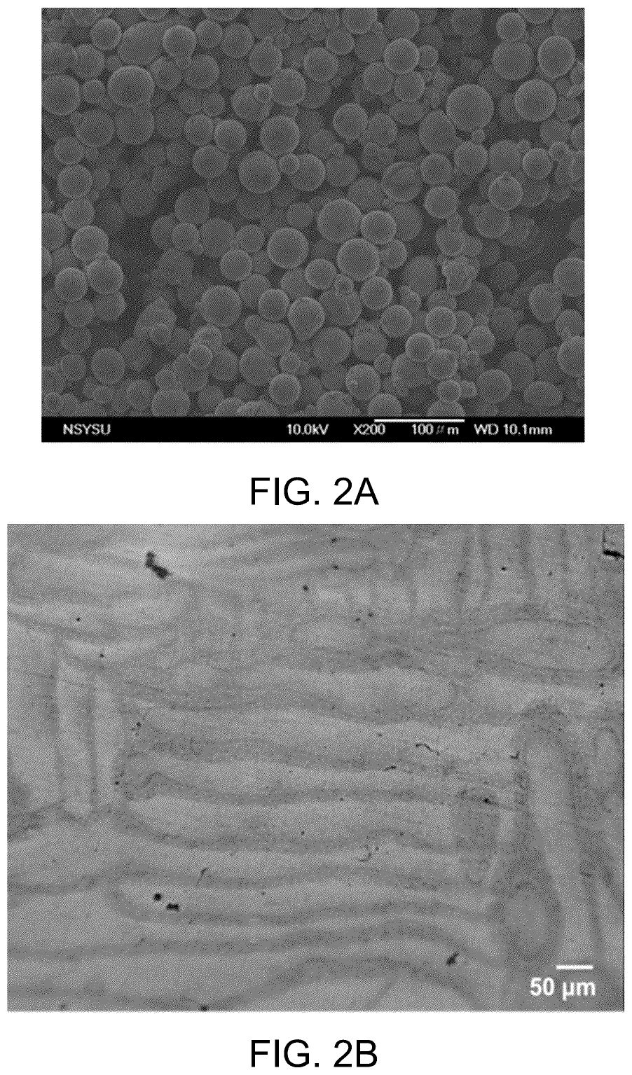

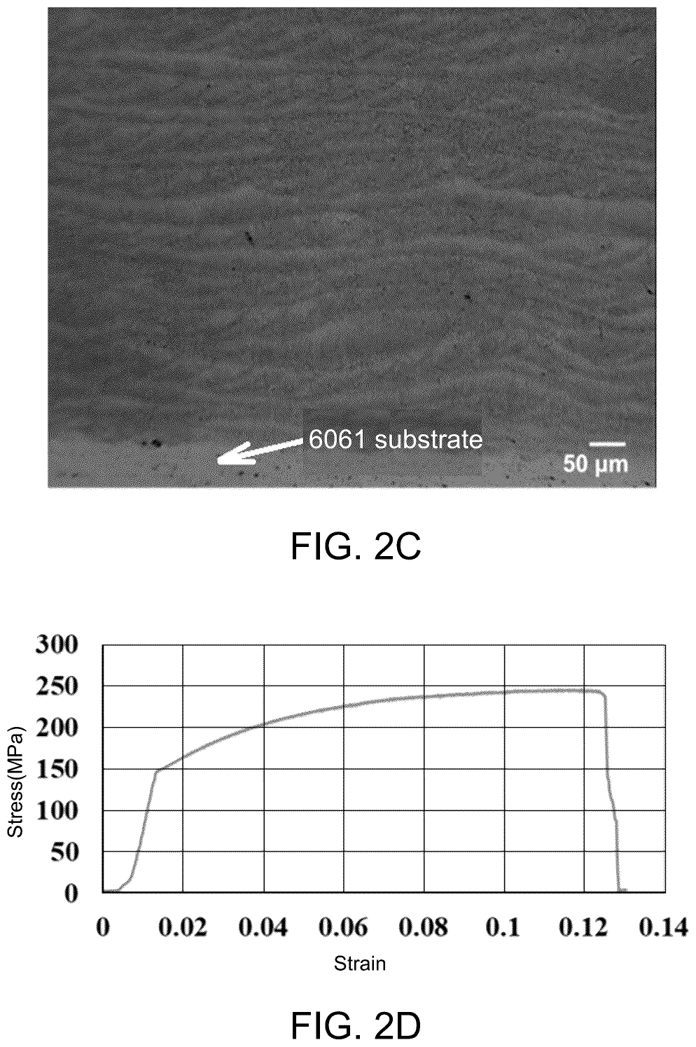

Then, aluminum alloy powders were manufactured by adopting a method of gas powder injection, and a metallograph of the aluminum alloy powders was observed. A result is shown in FIG. 2A. Conditions of the gas powder injection were as follows:
1. Equipment: a self-made gas atomizing device.
2. A temperature when gas atomizing was conducted on an aluminum liquid: 800° C.
3. A pressure of gas atomizing: 22 bar.
4. A flow rate of gas atomizing: 5.5 m³/min.

In FIG. 2A, it is observed that aluminum alloy powders are presented in a spherical shape, and grain sizes of the aluminum alloy powders are around several dozens of μm.

Next, laminated manufacturing was conducted under the following conditions.
1. Equipment: AMP-160 metallic powder bed laminated manufacturing device manufactured by Tongtai Machine & Tool Co., Ltd.
2. Scanning speed: 1200 mm/s.
3. Scanning power: 350 W.
4. Hatch spacing: 50 μm.
5. A thickness of each layer of aluminum powders: 30 μm.

A metallographical observation was conducted on the manufactured melt, as shown in FIG. 2B and FIG. 2C. In addition, a mechanical property test was conducted on the manufactured melt, and the result is shown in FIG. 2D and Table 2. UTS represents tensile strength. YS represents yield strength. El. represents elongation.

TABLE 2

| Si | Mg | UTS(MPa) | YS(MPa) | EL. (%) | Density (%) |
|---|---|---|---|---|---|
| 3.5 wt. % | 0.7 wt. % | 249.5 ± 9.6 | 156.3 ± 14.9 | 12.4 ± 0.8 | 99.20% |

*The rest of the composition is aluminum.

As shown in FIG. 2B and FIG. 2C, a laminated structure of the melt of Experimental Example 1 without any cracks is observed from both of the front-view and the cross-sectional view. Furthermore, as shown in Table 1 above, it is verified that the melt exhibits the yield strength that is greater than 150 MPa and the tensile strength that is approximately 250 MPa.

### Comparative Example 1

The conventional 6061 aluminum alloy of Table 1 was adopted as a raw material. Blocks were obtained through 7 hours of homogenization heat treatment at 570° C.

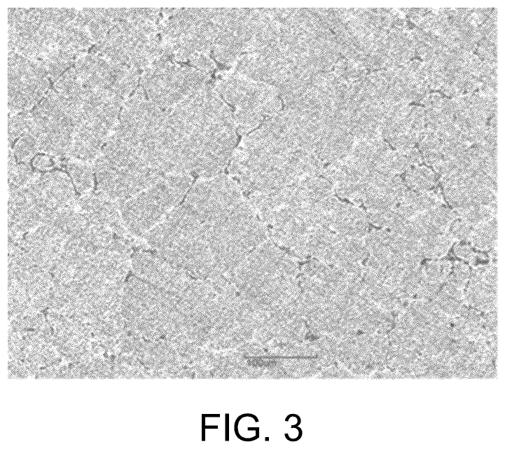

A metallographical observation and a mechanical property test were conducted on the blocks. The results are shown in FIG. 3 and Table 3.

TABLE 3

| Sample | UTS(MPa) | YS(MPa) | El. (%) |
|---|---|---|---|
| 1 | 147.3 | 70.2 | 15.6 |
| 2 | 148.2 | 68.5 | 17.4 |
| 3 | 144.6 | 72.2 | 16.9 |
| Average | 146.7 | 70.3 | 16.6 |

In FIG. 3, it is observed that a metallograph of the 6061 aluminum alloy is uniform, and a density of the 6061 aluminum alloy is 99.1%. In Table 3 above, it is obtained that the yield strength and the tensile strength of the 6061 aluminum alloy are not high. It is noted that the highest yield strength thereof is only 72.2 MPa.

### Comparative Example 2

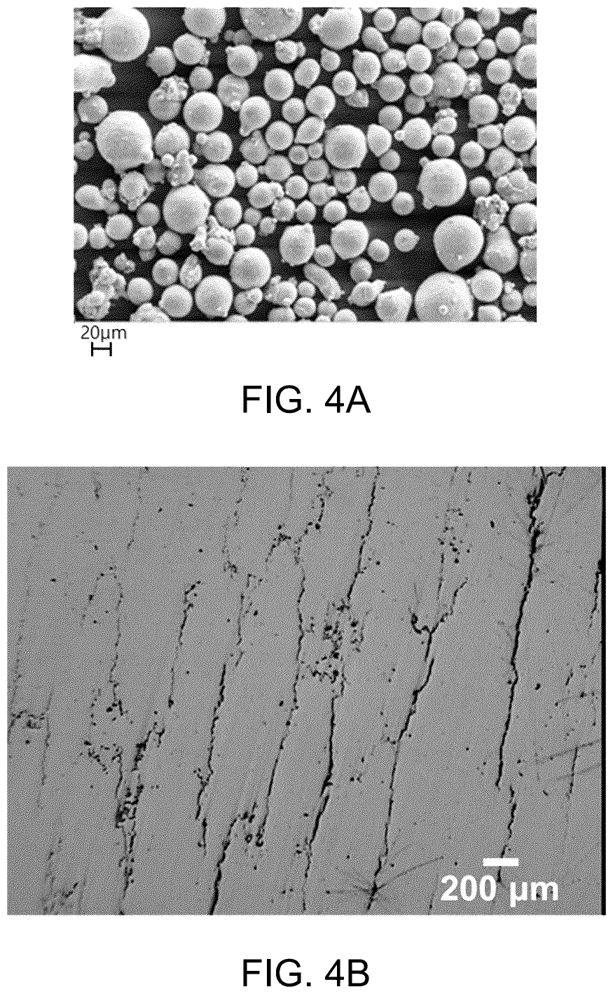

The conventional 6061 aluminum alloy of Table 1 was adopted as a raw material. Powders were manufactured according to the method of Experimental Example 1. A metallograph of the powders was observed, and the result is shown in FIG. 4A.

In FIG. 4A, it is observed that although the aluminum alloy powders are also spherical, there is a greater disparity among grain sizes of the aluminum alloy powders.

Next, a melt was manufactured with the powders according to the laminated manufacturing conditions of Experimental Example 1. A metallographical observation and a mechanical property test were conducted on the manufactured melt. The results are shown in FIG. 4B and Table 4.

TABLE 4

| UTS(MPa) | YS(MPa) | El.(%) | Density (%) |
|---|---|---|---|
| 78.3 | -(Brittle | 0.5 | 92.80% |
| | fracture) | | |

In FIG. 4B, it is observed that the melt of Comparative Example 2 has a great number of cracks. In addition, in Table 4 above, it is obtained that the tensile strength of the melt is unfavorable, and the elongation is extremely low. Furthermore, there are a great number of cracks in the structure, so the yield strength is unable to be measured.

The result of Comparative Example 2 may verify that the conventional 6061 aluminum alloy exhibits unfavorable castability. When the conventional 6061 aluminum alloy is in an environment of laminated manufacturing that requires rapid solidification, a molten liquid may not be supplied instantly. Hence, a great number of cracks are present in the melt, significantly affecting mechanical properties of the structure.

### Experimental Example 2

The conventional 6061 aluminum alloy of Table 1 was melted. Next, Si and Mg were added to make the composition ratio thereof in the entire aluminum alloy as shown in Table 5 below. Powders were manufactured according to the method of Experimental Example 1.

Next, melts were manufactured with the aluminum alloy powders according to the laminated manufacturing conditions of Experimental Example 1. A mechanical property test was respectively conducted on the manufactured melts. The results are shown in Table 5.

TABLE 5

| Si | Mg | UTS(MPa) | YS(MPa) | El. (%) | Density (%) |
|---|---|---|---|---|---|
| 2.0 wt. % | 0.4 wt. % | 128.7 ± 9.1 | 101.3 ± 2.9 | 2.4 ± 0.8 | 92.40% |
| 2.0 wt. % | 0.7 wt. % | 138.7 ± 11.8 | 123.5 ± 7.4 | 3.4 ± 0.9 | 92.90% |
| 2.0 wt. % | 1.0 wt. % | 126.4 ± 10.2 | 114.8 ± 5.3 | 2.0 ± 0.5 | 91.30% |
| 3.0 wt. % | 0.4 wt. % | 198.1 ± 7.8 | 110.3 ± 4.2 | 7.0 ± 1.2 | 98.10% |
| 3.0 wt. % | 0.7 wt. % | 208.9 ± 7.3 | 131.5 ± 0.8 | 6.6 ± 1.5 | 98.30% |
| 3.0 wt. % | 1.0 wt. % | 209.6 ± 4.6 | 152.6 ± 6.9 | 3.2 ± 0.6 | 97.90% |
| 4.0 wt. % | 0.4 wt. % | 236 ± 10.3 | 131.1 ± 16.2 | 11.7 ± 1.2 | 99.10% |
| 4.0 wt. % | 0.7 wt. % | 262.7 ± 14.7 | 159.2 ± 18.4 | 9.7 ± 1.6 | 98.90% |
| 4.0 wt. % | 1.0 wt. % | 260.5 ± 10.3 | 159.5 ± 12.3 | 8.2 ± 0.9 | 99.30% |

*The rest of the composition is aluminum.

In Table 5, it is obtained that in the disclosure, controlling a content of Si and a content of Mg in a certain range may cause yield strength that is greater than 150 MPa, which is more favorable than the homogenized block of the conventional 6061 aluminum alloy of Comparative Example 1. In addition, when the content of Si is 3.0 wt % to 4.0 wt % and the content of Mg is 0.1 wt % to 1.0 wt %, the tensile strength of the melts may be greater than 200 MPa or may be approximately 200 MPa. When the content of Mg is 0.4 wt % to 0.7 wt %, the elongation of the obtained melts is favorable.

### Experimental Example 3

A content of Mg that was added to a melted conventional 6061 aluminum alloy was fixed, but a content of Si that was added was changed. The composition ratio thereof in the entire aluminum alloy is as shown in Table 6 below. Powders were manufactured according to the method of Experimental Example 1.

Next, melts were manufactured with the aluminum alloy powders according to the laminated manufacturing conditions of Experimental Example 1. A mechanical property test was conducted on the manufactured melts. The results are shown in Table 6.

TABLE 6

| Si | Mg | UTS(MPa) | YS(MPa) | El. (%) | Density (%) |
|---|---|---|---|---|---|
| 2.5 wt. % | 0.7 wt. % | 173.6 ± 8.8 | 119.1 ± 4.3 | 4.6 ± 0.6 | 96.40% |
| 3.0 wt. % | 0.7 wt. % | 208.9 ± 7.3 | 131.5 ± 0.8 | 6.6 ± 1.5 | 98.30% |
| 3.5 wt. % | 0.7 wt. % | 249.5 ± 9.6 | 156.3 ± 14.9 | 12.4 ± 0.8 | 99.20% |
| 4.0 wt. % | 0.7 wt. % | 262.7 ± 14.7 | 159.2 ± 18.4 | 9.7 ± 1.6 | 98.90% |
| 4.5 wt. % | 0.7 wt. % | 281.5 ± 11.3 | 162.7 ± 16.4 | 7.8 ± 1.2 | 99.20% |

*The rest of the composition is aluminum.

In Table 6, it is obtained that controlling a content of Si in a certain range may cause yield strength that is greater than 100 MPa, which is more favorable than the homogenized block of the conventional 6061 aluminum alloy of Comparative Example 1. In addition, when the content of Si is 3.5 wt % to 4.5 wt % and the content of Mg is 0.7 wt %, the tensile strength of the melts may be greater than 250 MPa or may be approximately 250 MPa. The elongation of the obtained melts is greater than 7%.

### Experimental Example 4

A content of Si that was added to a melted conventional 6061 aluminum alloy was fixed, but a content of Mg that was added was changed. The composition ratio thereof in the entire aluminum alloy is as shown in Table 7 below. Powders were manufactured according to the method of Experimental Example 1.

Next, melts were manufactured with the aluminum alloy powders according to the laminated manufacturing conditions of Experimental Example 1. A mechanical property test was conducted on the manufactured melts. The results are shown in Table 7.

TABLE 7

| Si | Mg | UTS(MPa) | YS(MPa) | El.(%) | Density (%) |
|---|---|---|---|---|---|
| 3.5 wt. % | 0.1 wt. % | 219.5 ± 11.3 | 135.5 ± 8.4 | 12.8 ± 0.9 | 99.30% |
| 3.5 wt. % | 0.4 wt. % | 232.4 ± 12.7 | 143.4 ± 5.5 | 12.1 ± 1.5 | 98.80% |
| 3.5 wt. % | 0.7 wt. % | 249.5 ± 9.6 | 156.3 ± 14.9 | 12.4 ± 0.8 | 99.20% |
| 3.5 wt. % | 1.0 wt. % | 257.9 ± 13.1 | 153.5 ± 17.7 | 7.8 ± 0.7 | 99.40% |
| 3.5 wt. % | 1.3 wt. % | 276.3 ± 12.8 | 148.1 ±12.6 | 5.8 ± 1.8 | 98.90% |

*The rest of the composition is aluminum.

In Table 7, it is obtained that controlling a content of Mg in a certain range may cause tensile strength that is greater than 200 MPa, which is much higher than the results of Comparative Example 1 and Comparative Example 2. When the content of Mg is 0.1 wt % to 0.7 wt %, the elongation is greater than 12%.

In summary of the above, in the disclosure, through tempering the 6061 aluminum alloy with the content of Si and the content of Mg, the 6061 aluminum alloy suitable for laminated manufacturing may be manufactured. The 6061 aluminum alloy exhibits favorable yield strength and tensile strength. Unlike conventional aluminum alloy processing, laminated manufacturing does not have to include multiple manufacturing processes, the manufacturing process is fast and capable of manufacturing a complex and intricate structure. An order may be completed rapidly, and it is not necessary to manufacture a great number of products in advance. Therefore, an inventory number of materials of semiconductor equipment can be further reduced. In addition, through laminated manufacturing, a part required for certain old equipment may be manufactured.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An aluminum alloy melt manufactured by adopting an aluminum alloy powder through laser laminated manufacturing, wherein
the aluminum alloy powder comprises Si: 2.0 to 4.5 wt %; Mg: 0.1 to 1.3 wt %; Fe: 0.07 to 0.65 wt %; Cu: 0.35 wt % or less; Cr: 0.02 to 0.32 wt %; Zn: 0.23 wt % or less; Ti: 0.23 wt % or less; Mn: 0.13 wt % or less, wherein the rest of the aluminum alloy powders is aluminum and inevitable impurities.

2. The aluminum alloy melt according to claim 1, wherein yield strength of the aluminum alloy melt is greater than 100 MPa.

3. The aluminum alloy melt according to claim 1, wherein yield strength of the aluminum alloy melt is greater than 125 MPa.

4. The aluminum alloy melt according to claim 1, wherein tensile strength of the aluminum alloy melt is 150 MPa to 300 MPa.

5. The aluminum alloy melt according to claim 1, wherein tensile strength of the aluminum alloy melt is 200 MPa to 300 MPa.

6. The aluminum alloy melt according to claim 1, wherein a grain size of the aluminum alloy powder is 20 μm to 65 μm.

7. The aluminum alloy melt according to claim 1, wherein a content of Si in the aluminum alloy powder is 3.0 wt % to 4.0 wt %.

8. The aluminum alloy melt according to claim 1, wherein a content of Mg in the aluminum alloy powder is 0.1 wt % to 1.0 wt %.

9. The aluminum alloy melt according to claim 1, wherein a content of Mg in the aluminum alloy powder is 0.4 wt % to 0.7 wt %.

10. The aluminum alloy melt according to claim 1, wherein a content of Zn in the aluminum alloy powder is more than 0 to 0.23 wt %.

11. The aluminum alloy melt according to claim 1, wherein a content of Ti in the aluminum alloy powder is more than 0 to 0.23 wt %.

12. The aluminum alloy melt according to claim 1, wherein the aluminum alloy powder is manufactured by adding Si and Mg into melted 6061 aluminum alloy.
